(19) United States
(12) Patent Application Publication
(10) Pub. No.: US 2003/0086455 A1
(43) Pub. Date: May 8, 2003

(54) High speed semiconductor vertical cavity surface emitting laser driver circuit

(76) Inventors: Alexamicu Amclian Ciubotaru, Palm Bay, FL (US); Jacax Sanchez Garcia, San Sebastian Guipucoa (ES)

Correspondence Address: OPPENHEIMER WOLFF & DONNELLY, LLP, Suite 600, 1620 L Street, NW, Washington, DC, 20036, US

(21) Appl. No.: 10/001,457

(22) Filed: Oct. 24, 2001

(51) Int. Cl. H01S 3/00

(52) U.S. Cl. 372/38.02

(57) ABSTRACT

The present invention offers a low cost, reliable, on chip implementation that provides driving voltages to VCSEL devices. One feature of the invention is the buffer circuit that adjusts the buffered driving voltage using feedback from the output circuit. The present invention therefore may be used in a varying number of VCSEL circuits that require different voltage levels and headrooms for proper operation.

### CROSS REFERENCE TO RELATED APPLICATIONS

None

### STATEMENT REGARDING FEDERALLY SPONSORED RESEARCH

None

### BACKGROUND OF THE INVENTION

The invention relates to a method and apparatus for driving high speed VCSEL circuits.

The term VCSEL stands for Vertical Cavity Surface Emitting Laser. These relatively new devices are semiconductor devices that emit light from a flat surface area of a chip analogous to an LED. The VCSEL device offers the performance advantages of an LED while producing laser type light. The application of these devices are numerous and varied. The present invention would use VCSEL's in an ethernet or optical data transmitting environment.

As VCSEL devices are connected in a common cathode configuration, switching current through them at high speeds is a challenge. This is primarily due to the unavailability in integrated circuits of high speed current sourcing devices such as pnp or PMOS transistors. The npn transistors available in integrated circuits are capable of high speed operation, however it is difficult to use them because of the low output headroom dictated by the ground-connected VCSEL's.

### SUMMARY OF THE INVENTION

The present invention is a buffer and output stage for providing the high-speed data signal to a common cathode VCSEL. The differential output signals of the buffer have a common-mode voltage that allows the transistors in the output stage to operate at high speeds with minimum collector-emitter voltages. The buffer has an adaptive feature for accommodating different VCSEL drive currents and for ensuring a proper bias voltage across the tail current source of the output differential stage. Also covered by this disclosure is a current-splitting technique that is used in the output stage for minimizing the transient currents through the bias source. The present invention includes three separate embodiments of the buffer circuit and two separate embodiments of the output stage circuit.

### BRIEF DESCRIPTION OF THE DRAWINGS

FIG. 1 shows a block diagram of the high speed VCSEL driver circuit.

FIG. 2 shows a first embodiment of the buffer stage of the VCSEL driver circuit as in the present invention.

FIG. 3 shows a first embodiment of the output stage of the VCSEL driver circuit of the present invention.

FIG. 4 shows a second embodiment of the buffer stage of the VCSEL driver circuit as in the present invention.

FIG. 5 shows a third embodiment of the buffer stage of the VCSEL driver circuit as in the present invention.

FIG. 6 shows a second embodiment of the output stage of the VCSEL driver circuit as in the present invention.

### DETAILED DESCRIPTION OF THE INVENTION

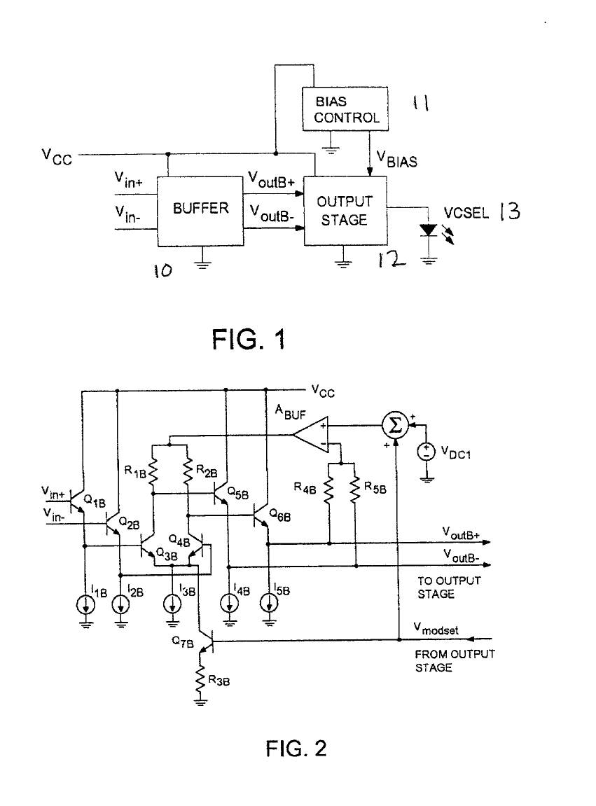

A block diagram of the driver which is composed of a buffer stage (10) an output stage (12) and a bias control (11) connected as shown in FIG. 1. The driver circuit operates from a single power supply and provides high-speed current data to a grounded-cathode VCSEL (13). The buffer (10) accepts the differential signals Vin+ and Vin− from another circuit which may be present on the same chip, and provides the differential signals VoutB+ and VoutB− to the npn output stage (12). A bias control circuit (11) provides an adjustable dc bias voltage VBIAS to the output stage (12). Prior art circuits do not employ any type of buffer circuit as disclosed in the present invention. The present invention allows for high speed npn transistors to be used to drive VCSEL's connected in a common cathode configuration.

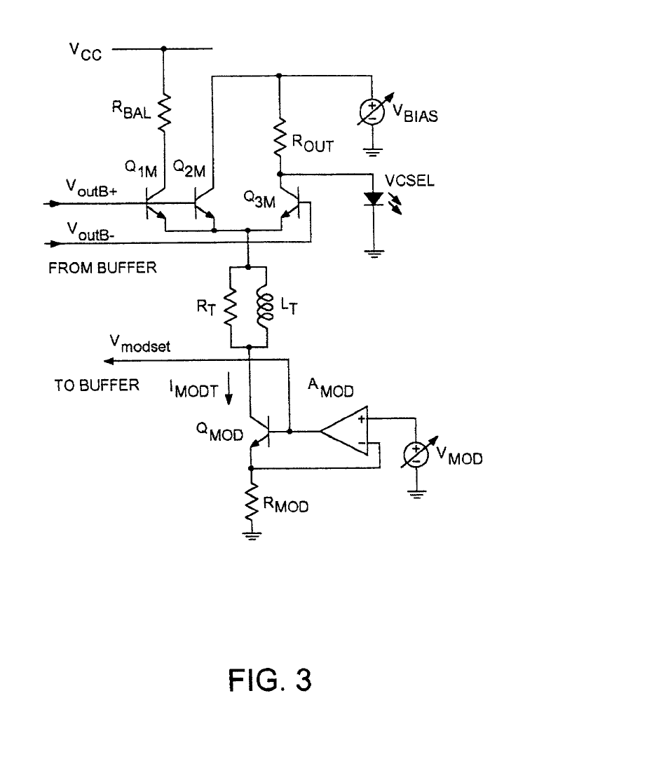

A first embodiment of the present invention can be seen in FIG. 2. FIG. 2 is a schematic diagram of the buffer (10) as shown in FIG. 1. The inputs to the buffer Vin+ and Vin− are first applied into emitter followers Q1B and Q2B. This differential signal is then applied to the differential pair comprising Q3B and Q4B. The output signal of the differential pair is developed across identical collector resistors R1B and R2B and then applied to the output stage shown in FIG. 3. Emitter followers Q5B and Q6B are used to couple the signal to the output stage (12). The dc voltage Vmodset, generated in the output stage of FIG. 3, is used in the circuit of FIG. 2. This voltage, along with transistor Q7B and resistor R3B, provides for the adaptive drive feature of the present invention. This adaptive drive feature allows for the output voltages provided by the buffer to be larger when the VCSEL modulation current is larger.

The amplifier ABUF and resistors R4B and R5B essentially close a feedback loop that provides an appropriate operating condition in this circuit. This operating condition is that the common-mode voltage of the buffer output signals VoutB+ and VoutB− equals Vmodset+VDC1. In this way the buffer circuit outputs the proper voltages that will be used in the next circuit, i.e. the output stage of the driver. This compensation allows the buffer of the present invention to be used in a variety of VCSEL driver circuits. If the gain of amplifier ABUF is much greater than one, the common mode voltage VoutBcm may be calculated as

$$V o u t B c m = \frac{VoutB ++ VoutB}{2} ≅ Vmodset + VDC1 \qquad ( 1 )$$

The output stage of the present invention is shown in FIG. 3. The differential output signals of the buffer VoutB+ and VoutB− are applied to the differential amplifier made up of transistors Q1M, Q2M and Q3M. The modulation current IMODT is generated in a closed-loop configuration using operational amplifier AMOD, transistor QMOD and resistor RMOD, and an external adjustable voltage VMOD. This current is switched through Q3M according to the polarity of (VoutB+−VoutB−). An output resistor ROUT, whose value is matched to the internal resistance of the VCSEL, is used in conjunction with a voltage VBIAS (which may also be generated by an operational amplifier) to establish the desired bias current through the VCSEL. The areas of transistors Q1M and Q2M are exactly half the area of transistor Q3M for ensuring minimum transient currents through VBIAS. On-chip inductor LT is used in series with the collector of QMOD for increasing the impedance of the modulation current source at high frequencies. Resistor RT is connected in parallel with LT for minimizing the effect of possible resonances. A resistor RBAL is connected in series with the collector of Q1M for balancing the base-collector capacitance reflected through the Miller effect on the inputs of the differential amplifier.

Under dynamic conditions, transistor QMOD of FIG. 3 has minimum collector voltage (and maximum base-collector voltage) when VoutB+ and VoutB− become equal (and equal to the common-mode voltage VoutBcm given by equation (1)). Then, using equation (1), the maximum base-collector voltage of QMOD is obtained as:

VbcMODmax≅Vbe1M−VDC1. (2)

By properly generating VDC1 in the circuit of FIG. 2, it is possible to have VbcMODmax approximately equal to 0.2-0.3 V (slight forward bias for the base-collector junction), which ensures that QMOD is still practically in the forward active region and its collector voltage has the minimum possible value for high-speed operation. A value larger than 0.2 to 0.3 V for the forward bias voltage of the base-collector junction will push the transistor into saturation, where the transistor beta and output impedance are significantly degraded both at dc and at high frequencies.

Besides ensuring a minimum possible voltage for the collector voltage of QMOD, the small common-mode voltage VoutBcm also ensures the proper headroom for the output device Q3M in FIG. 3. Thus, if the input signal in FIG. 2 is overdriving the differential pair Q3B and Q4B, the maximum output buffer voltage present on the base of Q3M is:

$$V o u t B max = V o u t B c m + \frac{I3B \times R1B}{2} \qquad ( 3 )$$

If the minimum VCSEL voltage is denoted by VVCSELmin, the maximum base-collector voltage Vbc3Mmax of transistor Q3M is:

Vbc3Mmax=VoutBmax−VVCSELmin (4)

With VVCSELmin on the order of 1.4 V it is possible to obtain values on the order of 0.2 to 0.3 V for Vbc3Mmax as well as for VbcMODmax. This ensures high-speed operation and virtually the same device benefits as in the forward active region.

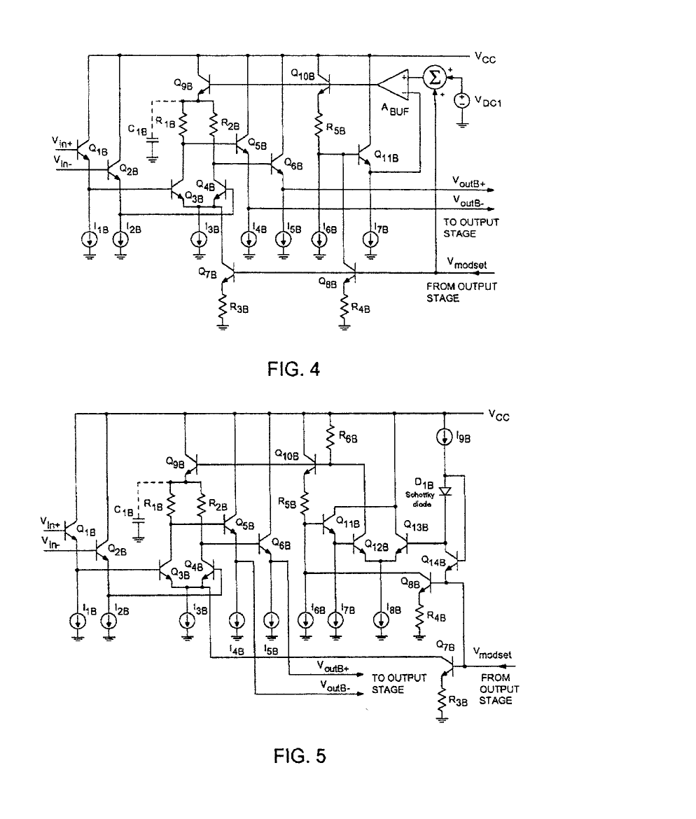

The buffer in FIG. 2 has the disadvantage that the common-mode voltage that is fed back to amplifier ABUF is obtained directly from the high-frequency output signals VoutB+ and VoutB−. This results in propagating any signal due to the mismatch between the two outputs through the low-frequency feedback loop. A circuit which eliminates this disadvantage is illustrated in FIG. 4, where the common-mode voltage fed to the amplifier is obtained indirectly by means of transistors Q9B and Q10B, resistor R5B, and current source I6B. In FIG. 4, assuming that all the transistor base-emitter voltages are equal (device scaling is used to ensure equal de current densities through the transistors), and the following conditions are met,

$$\frac{I3B \times R1B}{2} = I6B \times R5B$$

$$\frac{R1B}{2 R3B} = \frac{R5B}{R4B}$$

then the emitter voltage of Q11 is equal to the common-mode output voltage which is a function of dc currents only, even in the case of a mismatch in the signal path. In this way, the common-mode voltage of the high-frequency output differential signal is established by feedback in a separate low-frequency loop. An optional on-chip capacitor C1B can be connected as shown in FIG. 4. This capacitor prevents high-frequency transients on the emitter of Q9B due to the large-signal operation of the differential pair Q3B and Q4B from being injected into the feedback loop and provides good-quality ground-referenced output signals.

The circuit in FIG. 5 is similar to the circuit of FIG. 4, and details the implementation of amplifier ABUF using differential pair Q12B−Q13B and resistor R6B, and the implementation of VDC1 using transistor Q14B and Schottky diode D1B. With a properly chosen bias current I9B the diode voltage VD1B can be as low as 0.2 to 0.3 V and VDC1 becomes:

VDC1=Vbe14B−VD1B. (7)

Using equations (2) and (7), the maximum base-collector voltage of QMOD in FIG. 3 is approximately 0.2 to 0.3 V because:

VbcMODmax=Vbe1M−Vbe14B+VD1B≅VD1B. (8)

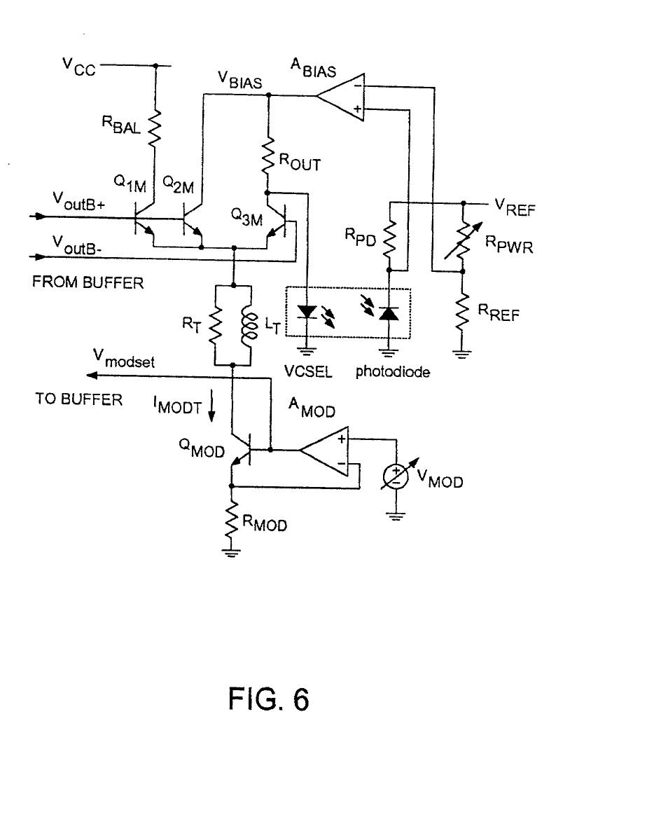

The circuit of FIG. 6 is similar to the circuit of FIG. 3 and has an additional loop for generating the bias voltage VBIAS. The circuit is intended for applications where there exists a photodiode optically coupled with the VCSEL. The feedback loop ensures that the current through the VCSEL is maintained at a prescribed value by developing a voltage across resistor RPD using the current of the photodiode, comparing it to an adjustable voltage set using resistor RREF and adjustable resistor RPWR, and amplifying the difference using amplifier ABIAS. The current splitting ensured by Q2M is used to minimize the current transients through the non-ideal output of ABIAS.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A VCSEL driver circuit comprising:
a buffer circuit having first and second input lines forming a differential input and a first and second output lines for outputting a buffered voltage signal; and
an output circuit that receives said buffered voltage signal to drive VCSEL devices connected in a common cathode configuration, wherein the output circuit feeds back a voltage signal back to the buffer circuit to ensure that the buffered voltage signal has a proper magnitude.

2. The driver circuit of claim 1 further comprising a bias control circuit.

3. The driver circuit of claim 1 wherein the buffer circuit contains a first and second transistor connected as emitter followers and a third and fourth transistor connected as a differential pair.

4. The driver circuit of claim 1 wherein the buffer circuit contains an operational amplifier which receives input signals fed back from the output stage and the buffered voltage signal.

5. The driver circuit of claim 4 wherein the operational amplifier is used to create a feedback loop to adjust the buffered voltage signal based on the necessary voltage required in the output circuit.

6. The driver circuit of claim 5 wherein the output circuit receives said buffered voltage signal into a differential amplifier comprised of three transistors.

7. The driver circuit of claim 6 wherein the output circuit contains a modulation circuit to drive the VCSEL devices wherein the modulation circuit generates the voltage signal that is fed back to the buffer circuit.

8. The driver circuit of claim 7 wherein the differential amplifier of the output circuit draws a constant current regardless of the polarity of the buffered voltage signal.

9. The driver circuit of claim 8 wherein the buffered voltage signal is a high frequency signal and is electrically isolated from dc biasing signals in the buffer circuit.

10. The driver circuit of claim 9 wherein the buffer circuit contains a Schottky diode to generate a common mode voltage of the buffered voltage signals.

11. A method of driving VCSEL devices comprising the steps of:
providing a high frequency data signal to a buffer circuit;
outputting a buffered voltage signal from the buffer circuit to an output circuit;
feeding back a signal from the output circuit to the buffer circuit in order to provide a buffered voltage signal of appropriate magnitude to the output circuit; and
applying a final output signal from the output circuit to the VCSEL devices.

12. The method of claim 11 further comprising the step of providing a bias control circuit.

13. The method of claim 11 further comprising the step of isolating the high frequency data signal from dc biasing signals.

14. The method of claim 13 further comprising the step of providing a feedback loop within the buffer circuit in order to adjust the common-mode voltage of the buffered voltage signals.

15. The method of claim 14 wherein the signals in the feedback loop include the high frequency data signals, the signal fed back to the buffer circuit from the output stage, and a voltage offset signal.

16. The method of claim 11 further comprising the step of providing a constant current source in the output circuit.

17. The method of claim 16 wherein the buffered voltage signal is applied to three transistors in the output circuit, wherein two of the three transistors draw a constant current regardless of the polarity of the buffered voltage signal.

18. A VCSEL driver circuit comprising:
a buffer circuit having first and second input lines forming a differential input and a first and second output lines for outputting a buffered voltage signal; and
an output circuit that receives said buffered voltage signal to drive VCSEL devices connected in a common cathode configuration, wherein the output circuit contains a current splitting circuit that minimizes current transients through the output circuit.

19. The driver circuit of claim 18 wherein the output circuit receives said buffered voltage signal into the current splitting circuit, wherein the current splitting circuit is a differential amplifier comprised of three transistors.

20. The driver circuit of claim 19 wherein the differential amplifier of the output circuit draws a constant current regardless of the polarity of the buffered voltage signal.
